(19) United States
(12) Patent Application Publication
(10) Pub. No.: US 2012/0300603 A1
(43) Pub. Date: Nov. 29, 2012

(54) OPTICAL DISC APPARATUS AND METHOD OF CONTROLLING THE SAME

(75) Inventor: Jae-Hyun KIM, Suwon-si (KR)

(73) Assignee: SAMSUNG ELECTRONICS CO., LTD., Suwon-si (KR)

(21) Appl. No.: 13/479,864

(22) Filed: May 24, 2012

(30) Foreign Application Priority Data
May 24, 2011 (KR) 10-2011-0049046

(51) Int. Cl. G11B 7/00

(52) U.S. Cl. 369/44.32; G9B/7

(57) ABSTRACT

An optical disc apparatus includes an optical pickup unit which reads data recorded on an optical disc and converts the data into a radio frequency (RF) signal. A defect detection unit detects a defect on the optical disc using the RF signal output from the optical pickup unit. A servo signal processing unit holds a servo control signal in a corresponding defective section when the defect is detected on the optical disc. A control unit detects the variance of the servo control signal after the defective section, and uses that as feedback so as to control a servo control signal of a subsequent defective section.

### CROSS-REFERENCE TO RELATED APPLICATION

This application claims priority from Korean Patent Application No. 10-2011-0049046, filed on May 24, 2011 in the Korean Intellectual Property Office, the disclosure of which is incorporated herein by reference in its entirety.

### BACKGROUND

1. Field

Apparatuses and methods consistent with exemplary embodiments relate to an optical disc apparatus and a method of controlling the same, and, more particularly, to an optical disc apparatus capable of controlling defects on an optical disc and a related control method.

2. Description of the Related Art

In general, an optical disc recording/reproducing apparatus reproduces information recorded on a disc. The disc may be any of several various types such as, but not limited to a compact disc (CD), a compact disc-read only memory (CD-ROM), a digital video disc (DVD), CD-recordable (CD-R), CD-rewritable (CD-RW), DVD±RW, or DVD-R. In addition to reproducing information already recorded on such discs, these apparatuses also record data on the disc. The optical disc recording/reproducing apparatus employs various servo controls including mechanical driving controls so as to accurately pick up a radio frequency (RF) signal from the optical disc. There are various types of servo controls, including focusing servo controls and tracking servo controls.

An optical disc recording/reproducing apparatus has a characteristic in that a signal is reproduced, using a non-contact type optical head, according to an amount of reflection. In particular, since the optical disc recording/reproducing apparatus uses a non-contact type optical head, quality degradation can be prevented. Also, reproduction performance even in the presence of dust or surface scratches is relatively strong, compared with a recording medium such as a tape which uses a contact type head.

On the other hand, when an optical disc is not contained in a cartridge, physical defects are more likely to occur during use on the reproducing surface or an opposite surface of the optical disc recording medium, as compared to the situation in which a cartridge is used. Such physical defects may include scratches on the disc surface, dust, interruption caused by the disc fabrication process, and the like. In an interruption defect, some sections of the data surface, on which data is to be or to have been recorded, are omitted.

The defects cause the reproduction signal to be distorted or omitted, and cause malfunctions in the servo signal, which itself is indispensable in signal reproduction. This makes it impossible or very difficult to carry out signal reproduction , so it is clear that these physical defects seriously affect the optical disc recording/reproducing apparatus. Therefore, the optical disc recording/reproducing apparatus is set so as to hold a servo control signal whenever a specific defect is encountered, and to generate the servo control signal again when the defective section is finished.

FIGS. 1A and 1B are views illustrating problems according to the related art.

As shown in FIGS. 1A and 1B, the approach of simply holding a servo control signal level does not feedback the servo control signal even in the situation that the previous servo control signal was unstable.

Further, when the defective section is long or focuses on one side, focus drop can occur or a track can be skipped, making it possible to record or reproduce an undesired region.

In general, when an RF signal causes defects it is not completely cleared and the signals before and after the RF signal are sloped. Therefore, when the RF signal is sliced and generates defect signals, the signals before and after the defect signal are not detected as defects. In addition, the RF signal itself has a bad influence on the servo control signal, making the servo hold control difficult. In this case, although the defect slice level is adjusted, the defect signal still occurs and the servo control is difficult in the case of, e.g., a fingerprint where it has advantageous to neglect the servo hold control.

### SUMMARY

One or more exemplary embodiments may overcome the above disadvantages, or other disadvantages not described above. However, it is understood that one or more exemplary embodiment are not required to overcome the disadvantages described above, and may not overcome any of the problems described above.

One or more exemplary embodiments provide an optical disc apparatus and control method which perform feedback defect control using a compensation value of a previously detected servo control signal method.

According to an aspect of an exemplary embodiment, an optical disc apparatus includes: an optical pickup unit which may read data recorded on an optical disc and may convert the data into a radio frequency (RF) signal; a defect detection unit which may detect one or more optical disc defects, of the optical disc, using the RF signal output from the optical pickup unit, where locations, on the optical disc, of the one or more optical disc defects, define one or more corresponding defective sections of the optical disc; a servo signal processing unit which may hold a servo control signal, in the one or more corresponding defective sections, when the one or more optical disc defects are detected by the detection unit; and a control unit which may detect a respective variance of the servo control signal after a given one of the one or more defective sections, so as to define a respective detected variance that corresponds to the given one of the one or more corresponding defective sections, and performs feedback control of the servo control signal, wherein the control unit performs the feedback control by using the respective detected variance for the given one of the one or more defective sections with respect to the servo control signal of a subsequent one of the one or more defective sections when a subsequent one of the one or more optical disc defects is detected.

According to an exemplary embodiment, the control unit may calculate a calculated compensation value to reduce the respective detected variance of the servo control signal after the given one of the one or more defective sections, and the control unit may apply the calculated compensation value to the servo control signal of the subsequent one of the one or more defective sections when the subsequent one of the one or more optical defects is detected.

The control unit may apply a compensation value that is calculated in a current defective section in relation to a compensation value calculated that is calculated after a previous defective section. That is to say, the calculated compensation value applied to the servo control signal of the subsequent one of the one or more defective sections also takes into account a respective detected variance of the servo control signal after a preceding one of the one or more defective sections.

The one or more defective sections may each have respective sizes, and the optical disc may have a plurality of track sectors, and when the respective sizes of the one or more defective sections differ, one from another, in a same track sector of the plurality of track sectors, the control unit may calculate the calculated compensation value, respectively, for each one of the one or more defective sections having the respective differing sizes in the same track sector.

The control unit may apply the calculated compensation value to the servo control signal in a compensation pulse, and the compensation pulse may be one of a kick pulse, a triangular pulse, and a rectangular pulse.

The compensation pulse applied to the servo control signal may have a respective level and a respective application direction calculated by the control unit.

The control unit may periodically monitor at least one of the one or more optical disc defects, and may perform the feedback control of the servo control signal only when the at least one of the one or more optical disc defects has a respective size that exceeds a threshold.

The servo control signal may be a tracking error signal and/or a focus error signal.

According to another exemplary embodiment, a method of controlling an optical disc includes reading data recorded on an optical disc and converting the data to a radio frequency (RF) signal; detecting one or more optical disc defects of the optical disc using the RF signal, wherein locations, on the optical disc, of the one or more optical disc defects, define one or more corresponding defective sections of the optical disc; holding a servo control signal in the one or more corresponding defective sections, when the one or more optical disc defects are detected; and detecting a respective variance of the servo control signal after a given one of the one or more defective sections, so as to define a respective detected variance that corresponds to the given one of the one or more corresponding defective sections, and performing feedback control of the servo control signal by using the respective detected variance for the given one of the one or more defective sections with respect to the servo control signal of a subsequent one of the one or more defective sections when a subsequent one of the one or more optical disc defects is detected.

The feedback controlling the servo control signal may include calculating a compensation value corresponding to a reduction in the variance of the servo control signal after the defective section and applying a calculated compensation to a servo control signal of a corresponding defective section when next defective section is detected.

The feedback controlling the servo control signal may include applying a relative compensation value such that there is a calculated compensation value to reduce the respective detected variance of the servo control signal after the given one of the one or more defective sections; and the calculated compensation value is applied to the servo control signal of the subsequent one of the one or more defective sections when the subsequent one of the one or more optical defects is detected.

The feedback controlling the servo control signal may include that the calculated compensation value applied to the servo control signal of the subsequent one of the one or more defective sections also takes into account a respective detected variance of the servo control signal after a preceding one of the one or more defective sections.

According to the exemplary embodiment, when the one or more defective sections each have different respective sizes, in a same track sector of the plurality of track sectors, the method includes calculating the calculated compensation value, respectively, for each one of the one or more defective sections having the respective differing sizes in the same track sector.

The feedback controlling the servo control signal may include applying the calculated compensation value to the servo control signal in an applied pulse such as a kick pulse, a triangular pulse, and/or a rectangular pulse.

The feedback controlling the servo control signal may include calculating a level and an application direction of the applied pulse corresponding to the calculated compensation value, and applying the level and application direction to the servo control signal.

The feedback controlling the servo control signal may include periodically monitoring a defect on the optical disc and performing the feedback control of the servo control signal only when the at least one of the one or more optical disc defects has a respective size that exceeds a threshold.

The servo control signal may be a tracking error signal and/or a focus error signal.

In another exemplary embodiment, an optical disc apparatus includes: an optical pickup unit, a defect detection unit, a servo signal processing unit, and a control unit. The optical pickup unit may obtains a signal reflected from an optical disc; the defect detection unit may analyze the reflected signal and output a defect detection signal; the servo signal processing unit may output a servo control signal based on the defect detection signal, the servo control signal output from the servo signal processing unit being held at the same level when the error detection signal indicates the presence of a current optical disc defect; and the control unit may carry out feedback control with respect to the servo control signal by combining the servo control signal with a compensation pulse.

In the optical disc apparatus in this exemplary embodiment, the compensation pulse may be calculated based on a variance of the servo control signal following the presence of the current optical disc defect.

The compensation pulse may be calculated for use in the presence of a subsequent optical disc defect based on the variance of the servo control signal following the current optical disc defect.

The compensation pulse may be calculated based also on the variance of the servo control signal following a preceding optical disc defect.

### BRIEF DESCRIPTION OF THE DRAWING FIGURES

The above and/or other aspects will be more apparent by describing in detail exemplary embodiments, with reference to the accompanying drawings, in which:

FIGS. 1A and 1B are views illustrating problems in the related art.

FIG. 2A and 2B are views illustrating optical disc apparatuses according to exemplary embodiments;

FIG. 3A and 3B are views illustrating a defect detection method of an optical disc according to an exemplary embodiment;

FIGS. 4A and 4B are views illustrating an effect by a defect control method according to an exemplary embodiment;

FIG. 5 is a view illustrating a variance application type according to an exemplary embodiment;

FIG. 6 is a flowchart illustrating a method of controlling an optical disc apparatus according to an exemplary embodiment; and

FIG. 7 is a flowchart illustrating a method of controlling an optical disc apparatus according to an exemplary embodiment.

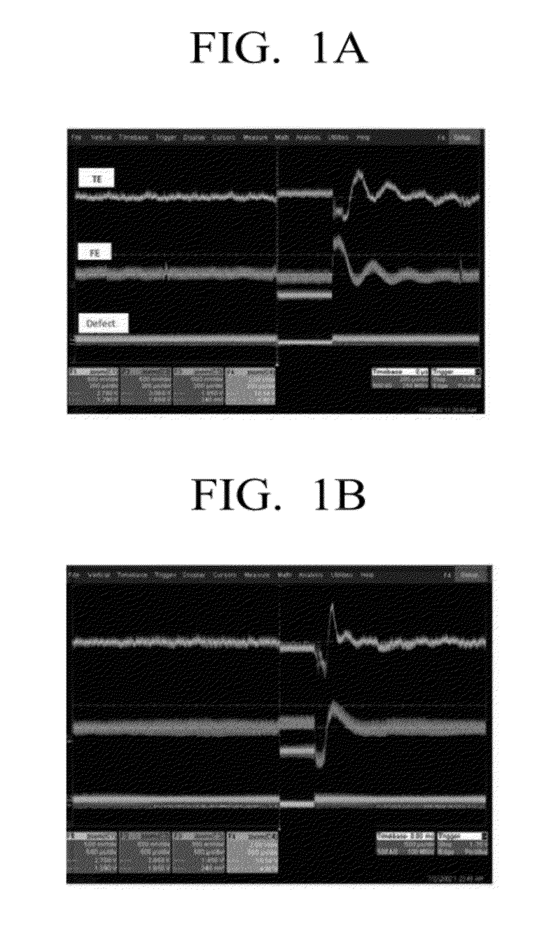

### DETAILED DESCRIPTION OF THE EXEMPLARY EMBODIMENTS

Hereinafter, exemplary embodiments will be described in greater detail with reference to the accompanying drawings.

In the following description, the same reference numerals are used for the same elements when they are depicted in different drawings. Construction details and particular elements mentioned below are provided to help give the reader a comprehensive understanding of the exemplary embodiments. Thus, it is apparent that the exemplary embodiments can be carried out without those specifically defined features. Also, some functions or elements are sufficiently known to those familiar with this field, and are thus omitted or are not described in detail since they would obscure the exemplary embodiments with unnecessary detail.

The term “unit” as used herein means a hardware component and/or a software component that is executed by a hardware component such as a processor.

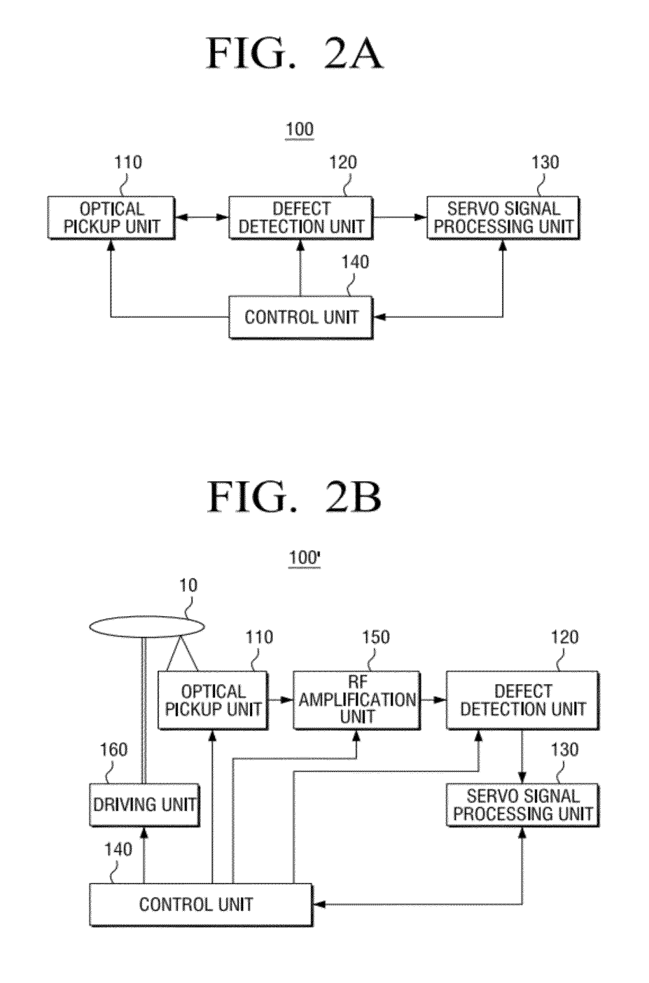

FIG. 2A is a block diagram illustrating a configuration of an optical disc apparatus according to an exemplary embodiment.

An optical pickup unit 110 reads data recorded on an optical disc. Specifically, the optical pickup unit 110 radiates light to a surface of the optical disc to be reflected. The reflected light is sensed, thereby reading the data recorded on the optical disc. Further, the optical pickup unit 110 may also perform a recording function on an optical disc (see 10 of FIG. 2B).

Here, the optical disc denotes a disc which records data using light. The optical disc 10 may be, for example, a compact disc (CD), a digital video disc (DVD), a blue-ray disc (BD), or the like. In various types of discs, various formats such as compact disc-recordable (CD-R), DVD-R, DVD+R, blue-ray disc-rewritable (BD-RW) may be used.

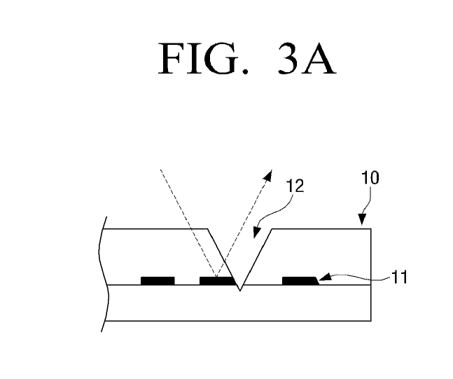

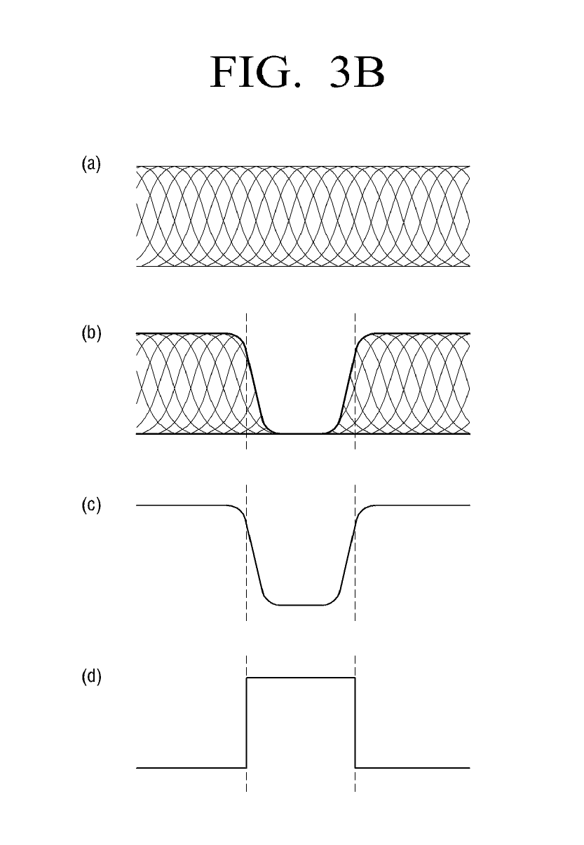

The defect detection unit 120 may detect a defect on the optical disc using a radio frequency (RF) signal output from the optical pickup unit 110. Specifically, the defect detection unit 120 determines whether or not the defect exists on the optical disc based on the defect signal generated using the RF signal. The defect detection method will be described with reference to FIGS. 3A and 3B later.

The servo signal processing unit 130 generates and provides a servo control signal. This control signal serves to help in performing mechanical servo control and is intended for use in accurately picking up the RF signal from the optical disc. Here, the servo control signal may be a tracking error signal (or tracking drive signal) and/or a focus error signal (or focus drive signal).

Specifically, the servo signal processing unit 130 may hold the servo control signal in a corresponding defective section when the defect is detected on the optical disc under control of the control unit 140. Here, the holding of the servo control signal means to temporarily stop consecutive control according to the error signal being detected and to maintain a previous servo control signal value.

Further, the servo signal processing unit 130 generates and provides a normal servo control signal when the defective section is finished. That is to say, when the section is no longer being written or read.

The control unit 140 controls an overall operation of the optical disc apparatus (100).

For example, the control unit 140 controls the optical pickup unit 110 so as to output the data read from the optical pickup unit 110 through a data input/output unit (not shown). In addition, the control unit 140 may control the optical pickup unit 110 to record on the optical disc data received from the data input/output unit.

In particular, the control unit 140 may carry out feedback control of a servo control signal of a corresponding defective section when a next or subsequent defect is detected using the variance of a servo control signal after the defective section corresponding to the defect detected by the defect detection unit 120. Here, the defective section may be an interval from a point in time when a detected defective portion starts to a point in time when the defect is finished or no longer occurs.

Specifically, the control unit 140 may calculate a compensation value corresponding to a value intended to reduce the variance of the servo control signal after leaving the defective section. The control unit 140 may also apply a calculated compensation value to the servo control signal generated for control during the corresponding defective section when the next defective section is encountered.

For example, when a focusing error signal is used, the control unit 140 may sample the voltage that is monitored after leaving the defective section, calculate a voltage corresponding to a sampled voltage, calculate the compensation value meant to reduce a calculated voltage. Specifically, the control unit 140 may calculate a pulse level and a pulse application direction when the compensation value is applied as a pulse type.

Alternatively, the control unit 140 may apply a compensation value in a relative manner; the compensation value is thus calculated in a current, or given, defective section relative to the compensation value that was calculated after the previous defective section. The result of this relative calculation approach is a compensation value to be applied to the servo control signal at the next or subsequent defective section. To put it another way, a compensation value to be used in an upcoming defective section is based on a current compensation value and a preceding compensation value.

For example, the control unit 140 may accumulate compensation values through a method of subtracting the compensation value in the current defective section from the compensation value calculated in the preceding defective section. The control unit 140 may likewise accumulate compensation values through adding the compensation value in the current defective section to the compensation value to the preceding defective section and calculate the compensation value to be applied to the servo control signal of the subsequent defective section.

Alternatively, the control unit 140 may calculate a compensation value corresponding to each defective section when a plurality of defective sections in one track sector have different size from each other and apply a calculated compensation value to a servo control signal in the next defective section.

The control unit 140 may apply the calculated compensation value to the servo control signal in what may be referred to as a compensation pulse. The compensation pulse may be a kick pulse, a triangular pulse, a rectangular pulse, or the like.

The control unit 140 may calculate the level and application direction of the compensation pulse that corresponds to the calculated compensation value, and apply to the servo control signal the compensation pulse at the calculated level and application direction.

Alternatively, the control unit 140 may periodically monitor a defect on the optical disc and carry out feedback control of the servo control signal when a detected defect has a size larger than a preset size or threshold, as described above. That is, when the defect on the optical disc has a size less than the threshold, the control unit 140 may perform defect control by simply holding the servo control signal level without performing the feedback control.

By simply holding the servo control signal level, it is possible to compensate an error component to be generated. That is, since an error component is already in the error signal (or the servo control signal) at the point in time when the defective section is sensed, it is possible to compensate for a more serious swing of an output signal by an image of the error component at the point in time when the servo holding is finished.

FIG. 2B is a block diagram illustrating a detailed configuration of the optical disc apparatus of FIG. 2A.

Referring to FIG. 2B, the optical disc apparatus 100′ includes an optical pickup unit 110, a defect detection unit 120, a servo signal processing unit 130, a control unit 140, a radio frequency (RF) amplification unit 150, and a driving unit 160. A detailed description of the components of FIG. 2B that overlap those of FIG. 2A will be omitted.

The optical pickup unit 110 is driven by a tracking actuator (not shown) for controlling a tracking servo. It is also driven by a focusing actuator (not shown) for controlling a focus servo. The optical pickup unit 110 optically picks up information recorded on an optical disc 10, and converts the information to an electric RF signal.

The RF amplification unit 150 amplifies the RF signal output from the optical pickup unit 110. The RF amplification unit 150 may embed a focus error detection circuit and a tracking error detection circuit to generate a focus error signal FE and a tracking error signal TE from an amplification RF signal.

The defect detection unit 120 may detect a defect on the optical disc 10 using the RF signal output from the optical pickup unit 110.

Specifically, the defect detection unit 120 may slice a peak of the RF signal, a bottom of the RF signal, and the like at a level appropriate to generate a defect signal.

A servo signal processing unit 130 is constituted of a focus control loop and a tracking servo control loop. The servo signal processing unit 130 compensates the gain and the phase for the focus error signal FE and the tracking error signal TE generated from the RF amplification unit 150, and generates a focus drive signal FOD and a tracking drive signal TRD.

The driving unit 150 drives a disc motor (not shown), the focusing actuator and the tracking actuator in the optical pickup unit 110. To do this, the driving unit 150 uses the focus drive signal FOD and the tracking drive signal TRD output from the servo signal processing unit 130.

The disc motor rotates the optical disc 10 in accordance with a disc driving signal output from the driving unit 160 in a constant linear velocity (CLV) type or a constant angular velocity (CAV) type.

The control unit 140 controls an overall operation of the optical disc apparatus 100′.

In particular, the control unit 140 may perform a feedback control for the servo control signal of a corresponding defective section when the next defect is detected, by varying the servo control signal after the defective section corresponding to the defect detected by the defect detection unit 120. Here, the defective section may be an interval from a point in time when the detected defect starts to a point in time when the detected defect is finished.

Specifically, the control unit 140 may calculate a compensation value that corresponds to a value that can reduce the variance of the servo control signal after the defective section and apply a calculated compensation value to a servo control signal of a corresponding defective section when next defective section is detected.

Alternatively, the control unit 140 may apply a compensation value calculated in a relative manner, i.e., the compensation value in a current defective section is applied to a compensation value calculated after a preceding defective section so as to calculate a compensation value to be applied to a servo control signal in the subsequent defective section. For example, when the compensation value in the previous defective section is 100, the control unit 140 may subtract or add the compensation value calculated in the current defective section from or to the compensation value in the previous defective section which is 100 and calculate the compensation value to be applied to the servo control signal of the next defective section.

The control unit 140 may apply the calculated compensation value to the servo control signal as a compensation pulse. The compensation pulse may be a kick pulse, a triangular pulse, or a rectangular pulse.

The control unit 140 may periodically monitor a defect on the optical disc and, when a detected defect has a size larger than a preset size or threshold, perform feedback control of the servo control signal as described above.

FIGS. 3A and 3B are views illustrating a method of detecting a defect on the optical disc according to an exemplary embodiment.

As an example, the detection of a scratch defect will be described with respect to FIG. 3A.

Referring to FIG. 3A, a defect 12 of the optical disc 10 may be detected through a recording and reproducing signal using light, that is, an RF signal in the form of light (indicated as a dotted line) reflected from a recording layer 11 of the optical disc 10.

A defect detection method will be described in more detail with reference to FIG. 3B. When there is no particular defect in the optical disc 10, the light reflected from the recording layer 11 generates an RF signal of constant alternating current (AC) as shown in FIG. 3b(a).

However, when there is a defect on the optical disc, the reflection is imperfect, and may be dispersed or directed away from the normal direction, and the RF signal thus reflected from the defective portion of the optical disc might be indicated by a gap in a detected reflection signal, as shown in FIG. 3B(b).

An output waveform as shown in FIG. 3B(c) may be generated from the detected RF signals as shown in FIGS. 3B(a) and 3B(b) through a top holder circuit (not shown) and the output waveform in FIG. 3B(c) may be inverted to generate a defect detection signal as shown in FIG. 3B(d), thereby indicating the presence of a defect on the optical disc.

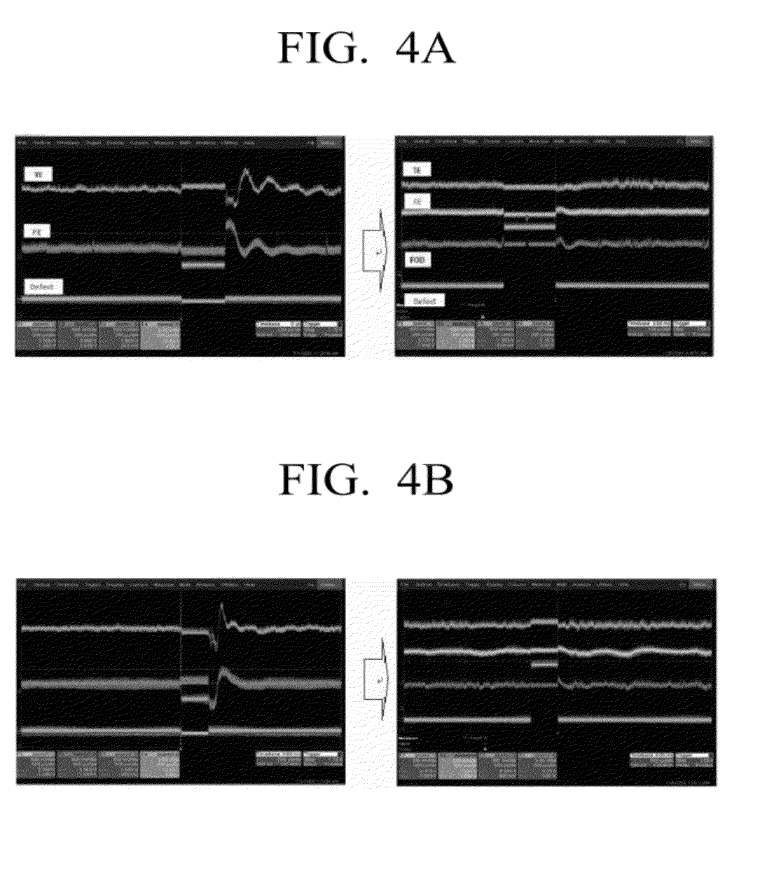

FIGS. 4A and 4B are views that show the effect of employing a defect control method according to an exemplary embodiment.

Referring to the graph in the left in FIG. 4A, the compensation value may be calculated on the basis of variances of a tracking error signal TE and a focusing error signal (FE) after the defective section.

Subsequently, referring to a graph in the right of FIG. 4A, a compensation value calculated in the graph of FIG. 4A may be provided as a compensation pulse (a kick pulse type in this example) to a servo control signal such as, in this instance, the focusing drive signal (FOD) in next defective section.

Referring to a graph illustrated in the left of FIG. 4B, a compensation value may calculated on the basis of variances of a tracking drive signal (TRD) and a focusing drive signal (FOD) after the defective section.

Subsequently, referring to a graph illustrated in the right of FIG. 4B, a compensation value calculated in the graph illustrated in FIG. 4A may be provided as a compensation pulse to a servo control signal (the focusing drive signal (FOD) in this example) after the next defective section. In this instance, the compensation pulse is a kick pulse type.

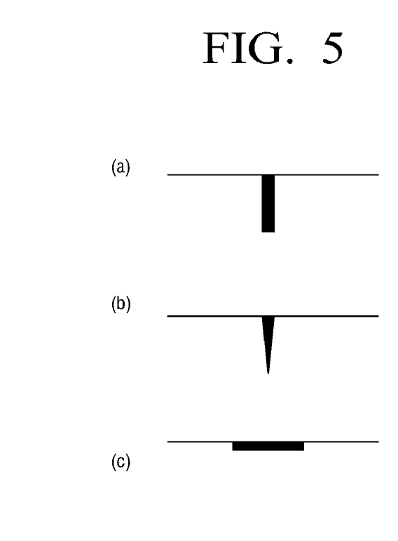

FIG. 5 is a view illustrating a variance application type according to various exemplary embodiments.

As shown in FIG. 5(a), a variance of a servo control signal detected after a defective section may be added to a held servo control signal of the next defective section in a kick pulse type of compensation pulse.

Alternatively, as shown in FIG. 5(b), a variance of a servo control signal detected after a defective section may be added to a held servo control signal of next defective section in a triangular pulse type of compensation pulse.

Alternatively, as shown in FIG. 5(c), a variance of a servo control signal detected after a defective section may be added to a held servo control signal of next defective section in a rectangular pulse type of compensation pulse.

The exemplary embodiments illustrated in FIG. 5 are only examples, and the variance may be provided in various types of compensation pulses.

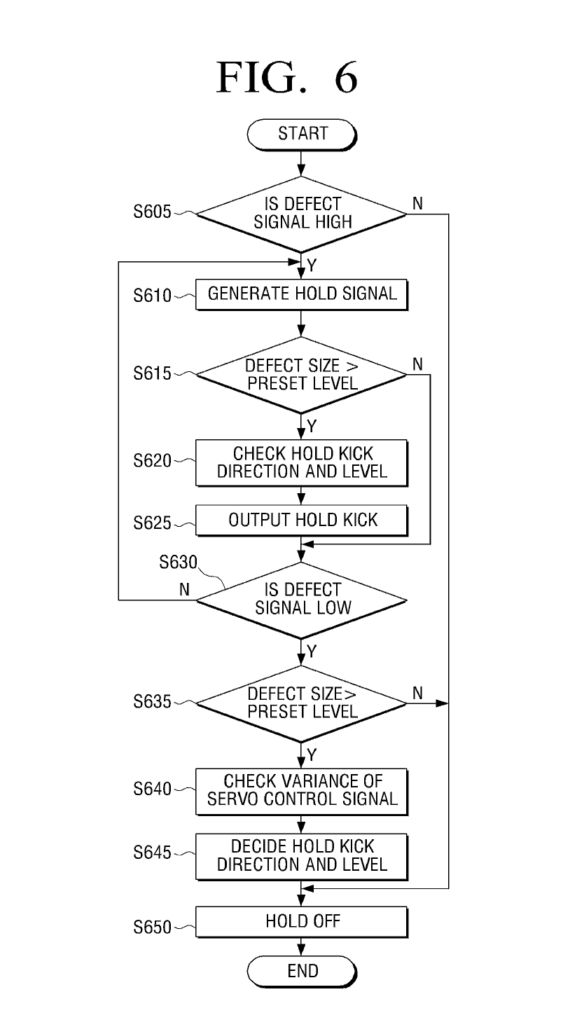

FIG. 6 is a flowchart illustrating a defect control method of an optical disc apparatus according to an exemplary embodiment.

According to the defect control method as shown in FIG. 6, first, it is determined whether or not a defect signal is high (S605).

As a result of the determination in S605, when the defect signal is high (S605:Y), a defect is on the disc, and a servo control signal (FOD and/or TRD) is held (S610).

Subsequently, the size of the defect is detected and a threshold check is carried out to see whether the defective section is large enough to warrant carrying out the rest of the procedure (S615).

When the defect has a size larger than the threshold (S615:Y), feedback control is performed for a variance previously measured and reflected (a variance of an FOD/TRD signal right after the defect signal). Specifically, the hold kick direction and the level are checked (S620).

Subsequently, a corresponding compensation pulse in the form of a hold kick is output (S625). That is, energy is added to a servo control signal so as to reduce the variance. For example, the variance may be a kick pulse type. Adaptive size and time of the kick pulse may be continuously varied by a variance at the point in time when the defect signal is finished.

Then, it is checked whether or not the defect signal has finished, and when the defect signal has a level larger than a constant level, a variance of the servo control signal may be checked and an amount of the defect signal to be applied to the kick pulse may be calculated. At this time, the size of the defect signal may be arbitrarily decided and the defect signal may be applied regardless of the size and level thereof. Thereby a variance due to an effect of a defect hold may be reflected when next defect is to be detected, resulting in more stable defect control.

Further, after the hold kick is output in S625, it is checked whether or not the defect signal is low (S630).

The result of the check in S630 guides further processing; when the defect signal is low (S630:Y), it is determined that the size of the defect signal is larger than the threshold (S635).

In S635, when the size of the defect size is larger than the threshold (S635:Y), the variance of servo control signal is checked (S640).

A compensation pulse (in this instance, a hold kick) direction and level are determined using the checking result of S640 and the hold is ended (S650).

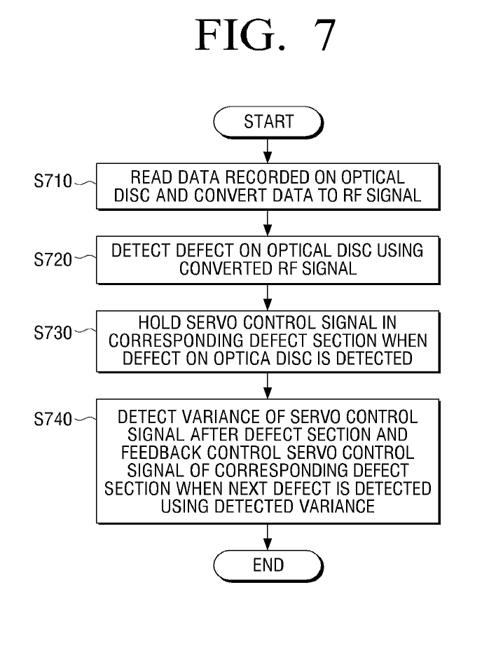

FIG. 7 is a flowchart illustrating a method of controlling an optical disc apparatus.

First, data recorded on the optical disc is read and the data thus read is converted to a RF signal (S710).

Subsequently, a defect on the optical disc is detected using a converted RF signal (S720).

When the defect is detected, a servo control signal in a corresponding defective section is held (S730).

Then, the variance in the servo control signal after the defective section is detected. When the next defect is detected, using a detected variance of the servo control signal, a servo control signal of the corresponding defective section may be feedback-controlled (S740).

Alternatively, in the feedback control process of S740, a compensation value may be calculated to determine a value that will reduce the variance of the servo control signal after the defective section. In addition, a calculated compensation value may be applied to a servo control signal of a corresponding defective section when next defective section is detected.

Alternatively, in the feedback control process of S740, a compensation value calculated in a current defective section may be applied, in a relative manner, to a compensation value calculated after a preceding defective section and a compensation value which is to be applied to a servo control signal of the subsequent defective section may be calculated.

Alternatively, in the feedback process of S740, when a plurality of defective sections having different sizes from each other exist in the same track sector, a compensation value corresponding to each of the plurality of defective sections can be calculated.

In the feedback control process of S740, the compensation value may be applied to the servo control signal in a compensation pulse. The compensation pulse may be a kick pulse, a triangular pulse, or a rectangular pulse.

Alternatively, in the feedback process of S740, a defect on the optical disc may be periodically monitored and when a detected defect has a size larger than a threshold, and a servo control signal can be feedback-controlled.

Here, the servo control signal may be at least one of a tracking error signal and a focus error signal.

Therefore, the variance of the defect signal may be adaptively fed back so as to more stably control the defect on the optical disc.

The inventive concepts may include a computer readable recording medium including a program for executing a method of controlling an optical disc apparatus as described above. The computer readable recording medium includes all kinds of recording apparatuses in which data to be read by a computer system is stored. Examples of a computer readable recording medium include, but are not limited to, the following types: read only memory (ROM), random access memory (RAM), CD-ROM, magnetic tape, floppy disc, and an optical data storage apparatus. The computer readable recording medium may be dispersed in computer systems connected to a network and a computer readable code may be stored and executed in a dispersion method.

As described above, according to the exemplary embodiments, the optical disc apparatus and the control method thereof adaptively feed the variance of a defect signal back so as to more stably control the defect on the optical disc.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those familiar with this field.

What is claimed is:

1. An optical disc apparatus comprising:
an optical pickup unit which reads data recorded on an optical disc and converts the data into a radio frequency (RF) signal;
a defect detection unit which detects one or more optical disc defects, of the optical disc, using the RF signal output from the optical pickup unit, wherein locations, on the optical disc, of the one or more optical disc defects, define one or more corresponding defective sections of the optical disc;
a servo signal processing unit which holds a servo control signal, in the one or more corresponding defective sections, when the one or more optical disc defects are detected by the detection unit; and
a control unit which detects a respective variance of the servo control signal after a given one of the one or more defective sections, so as to define a respective detected variance that corresponds to the given one of the one or more corresponding defective sections, and performs feedback control of the servo control signal, wherein the control unit performs the feedback control by using the respective detected variance for the given one of the one or more defective sections with respect to the servo control signal of a subsequent one of the one or more defective sections when a subsequent one of the one or more optical disc defects is detected.

2. The optical disc apparatus as claimed in claim 1, wherein:
the control unit calculates a calculated compensation value to reduce the respective detected variance of the servo control signal after the given one of the one or more defective sections; and
the control unit applies the calculated compensation value to the servo control signal of the subsequent one of the one or more defective sections when the subsequent one of the one or more optical defects is detected.

3. The optical disc apparatus as claimed in claim 2, wherein the calculated compensation value applied to the servo control signal of the subsequent one of the one or more defective sections also takes into account a respective detected variance of the servo control signal after a preceding one of the one or more defective sections.

4. The optical disc apparatus as claimed in claim 2, wherein:
the one or more defective sections each have respective sizes;
the optical disc has a plurality of track sectors; and
when the respective sizes of the one or more defective sections differ, one from another, in a same track sector of the plurality of track sectors, the control unit calculates the calculated compensation value, respectively, for each one of the one or more defective sections having the respective differing sizes in the same track sector.

5. The optical disc apparatus as claimed in claim 2, wherein the control unit applies the calculated compensation value to the servo control signal in a compensation pulse, and wherein the compensation pulse is one of a kick pulse, a triangular pulse, and a rectangular pulse.

6. The optical disc apparatus as claimed in claim 5, wherein, the compensation pulse applied to the servo control signal has a respective level and a respective application direction calculated by the control unit.

7. The optical disc apparatus as claimed in claim 1, wherein the control unit periodically monitors at least one of the one or more optical disc defects, and performs the feedback control of the servo control signal only when the at least one of the one or more optical disc defects has a respective size that exceeds a threshold.

8. The optical disc apparatus as claimed in claim 1, wherein the servo control signal is at least one of a tracking error signal and a focus error signal.

9. A method of controlling an optical disc apparatus, the method comprising:
reading data recorded on an optical disc and converting the data to a radio frequency (RF) signal;
detecting one or more optical disc defects of the optical disc using the RF signal, wherein locations, on the optical disc, of the one or more optical disc defects, define one or more corresponding defective sections of the optical disc;
holding a servo control signal in the one or more corresponding defective sections, when the one or more optical disc defects are detected; and
detecting a respective variance of the servo control signal after a given one of the one or more defective sections, so as to define a respective detected variance that corresponds to the given one of the one or more corresponding defective sections, and performing feedback control of the servo control signal by using the respective detected variance for the given one of the one or more defective sections with respect to the servo control signal of a subsequent one of the one or more defective sections when a subsequent one of the one or more optical disc defects is detected.

10. The method as claimed in claim 9, wherein the feedback controlling the servo control signal comprises:
a calculated compensation value to reduce the respective detected variance of the servo control signal after the given one of the one or more defective sections; and
applying the calculated compensation value to the servo control signal of the subsequent one of the one or more defective sections when the subsequent one of the one or more optical defects is detected.

11. The method as claimed in claim 10, wherein the calculated compensation value applied to the servo control signal of the subsequent one of the one or more defective sections also takes into account a respective detected variance of the servo control signal after a preceding one of the one or more defective sections.

12. The method as claimed in claim 10, wherein:
the one or more defective sections each have respective sizes;
the optical disc has a plurality of track sectors; and
when the respective sizes of the one or more defective sections differ, one from another, in a same track sector of the plurality of track sectors, the control unit calculates the calculated compensation value, respectively, for each one of the one or more defective sections having the respective differing sizes in the same track sector.

13. The method as claimed in claim 10, wherein the feedback control of the servo control signal includes applying the calculated compensation value to the servo control signal in a compensation pulse, and wherein the compensation pulse is one of a kick pulse, a triangular pulse, and a rectangular pulse.

14. The method as claimed in claim 13, wherein the feedback control of the servo control signal includes:
calculating a level and an application direction of the compensation pulse; and
applying the compensation pulse, at the calculated level and application direction.

15. The method as claimed in claim 9, wherein the feedback control of the servo control signal includes periodically monitoring at least one of the one or more optical disc defects, and performing the feedback control of the servo control signal only when the at least one of the one or more optical disc defects has a respective size that exceeds a threshold.

16. The display apparatus as claimed in claim 12, wherein the servo control signal is at least one of a tracking error signal and a focus error signal.

17. An optical disc apparatus, comprising:
an optical pickup unit, a defect detection unit, a servo signal processing unit, and a control unit;
wherein:
the optical pickup unit obtains a signal reflected from an optical disc;
the defect detection unit analyzes the reflected signal and outputs a defect detection signal;
the servo signal processing unit outputs a servo control signal based on the defect detection signal, the servo control signal output from the servo signal processing unit being held at the same level when the error detection signal indicates the presence of a current optical disc defect; and
the control unit carries out feedback control with respect to the servo control signal by combining the servo control signal with a compensation pulse.

18. The optical disc apparatus as set forth in claim 17, wherein the compensation pulse is calculated based on a variance of the servo control signal following the presence of the current optical disc defect.

19. The optical disc apparatus as set forth in claim 17, wherein the compensation pulse is calculated for use in the presence of a subsequent optical disc defect based on the variance of the servo control signal following the current optical disc defect.

20. The optical disc apparatus as set forth in claim 19, wherein the compensation pulse is calculated based also on the variance of the servo control signal following a preceding optical disc defect.
